(19) United States
(12) Patent Application Publication
(10) Pub. No.: US 2008/0085402 A1
(43) Pub. Date: Apr. 10, 2008

(54) METHOD FOR APPLYING A DECORATIVE LAYER AND PROTECTIVE COATING

(76) Inventor: Marshall E. Leininger, Canton, OH (US)

Correspondence Address: PEARNE & GORDON LLP, 1801 EAST 9TH STREET, SUITE 1200, CLEVELAND, OH, 44114-3108, US

(21) Appl. No.: 11/868,734

(22) Filed: Oct. 8, 2007

Related U.S. Application Data
(60) Provisional application No. 60/828,707, filed on Oct. 9, 2006.
(60) Provisional application No. 60/863,497, filed on Oct. 30, 2006.

(51) Int. Cl. B32B 3/00; B05D 1/36

(52) U.S. Cl. 428/200; 427/203

(57) ABSTRACT

A method for applying a decorative finish to a substrate is provided which includes the following steps. The method employs depositing a thermally-cured leveling layer overlying a substrate, and then subsequently depositing an intermediate layer such as a radiation-cured layer or decorative metal layer overlying the leveling layer. A top coat layer then is deposited overlying the intermediate layer. The top coat layer has particles dispersed therein to impart a decorative finish to the substrate. A layered structure made by the foregoing method also is provided.

This application claims the benefit of U.S. Prov. App. No. 60/828,707 filed Oct. 9, 2006, and also claims the benefit of U.S. Prov. App. No. 60/863,497 filed Oct. 30, 2006, the entire contents of all of which are hereby incorporated by reference.

### FIELD OF THE INVENTION

The invention relates generally to a substrate having a multi-layered coating to impart desired aesthetic characteristics and/or functional properties to the substrate. Methods for applying the multi-layered coating to a substrate are also described herein.

### DESCRIPTION OF RELATED ART

Decorative and aesthetic finishes are highly desirable in many industries that produce parts, devices and any other substrates capable of being coated. For example, the automotive industry produces various parts and trim components for which a decorative coating is desirable. With the advent of environmental regulations limiting the use of volatile organic compounds, such as solvents used in traditional liquid coating compositions, these industries have been motivated to use dry powder coatings that do not contain harsh solvents or liquid mediums. Markets affected by the environmental regulations include the automotive, industrial, appliance, and architectural coating industries.

Powder coatings have generally not been able to produce the desired aesthetic effects traditionally found in solvent-borne liquid coatings. However, the liquid coating compositions often require costly solvent venting, explosion prevention, and waste solvent recovery. Thus, the aforementioned coating markets desire dry powder-based coating compositions that can provide the desired effects, such as metallics, veins, sparkles, and textures, traditionally produced by various forms of liquid coating compositions. While powder-coating technology has advanced in the areas of metals, there is a need in the industry for a powder-based coating composition that can provide various textures, visual effects and overall durability.

It is desirable that the decorative or textured coatings be durable under harsh aid/or corrosive operating conditions. The durability of a decorative coating or finish is a factor in determining whether the coating will be accepted in the automotive industry. The automotive industry often requires that a decorative or textured coating pass standard durability tests which evaluate the adhesion of the coat to the underlying substrate or layer and its resistance to scratches, humidity, salt spray, chips, chemical etching, outdoor weathering, acid spray, thermal or physical shock and corrosion. There is a need for a process which can create a multi-toned, textured, sparkling and/or pearl-like decorative coating on a substrate that eliminates the use of liquid compositions which traditionally produce such decorative or textured finishes.

### SUMMARY OF THE INVENTION

A layered structure comprising a substrate, a thermally-cured leveling layer overlying the substrate, at least one intermediate layer overlying the thermally-cured leveling layer, and a thermally-cured top coat layer overlying the at least one intermediate layer. The thermally-cured top coat layer having dispersed therein particles selected from the group consisting of (a) decorative particles and (b) texture particles.

A method of applying a top coat layer over a substrate, the method comprising the steps of: a) providing a substrate having a substrate surface, b) providing a thermally-cured leveling layer overlying said substrate surface, c) providing at least one intermediate layer overlying said thermally-cured leveling layer, and d) providing a thermally-cured top coat layer overlying said at least one intermediate layer. The top coat layer having particles dispersed therein selected from the group consisting of (a) decorative particles and (b) texture particles.

### BRIEF DESCRIPTION OF THE DRAWINGS

FIG. 1 illustrates a cross-sectional view of a substrate with multiple layers formed thereon.

FIG. 2 illustrates a flow diagram of processing steps for applying a multi-layer coating to a substrate.

FIG. 3 illustrates a cross-sectional view of a substrate with multiple layers formed thereon.

FIG. 4 illustrates a cross-sectional view of a substrate with multiple layers formed thereon.

FIG. 5 illustrates a cross-sectional view of a substrate with multiple layers formed thereon.

### DETAILED DESCRIPTION OF PREFERRED EMBODIMENTS OF THE INVENTION

In the description that follows, when a preferred range such as 5 to 25 (or 5-25), is given, this means preferably at least 5 and, separately and independently, preferably not more than 25.

The term “substrate” refers to any material or surface to which a decorative coating is or can be applied by the methods described herein such as, without limitation, metals, alloys, thermoset polymers and other plastics, as well as composite materials and ceramics. Furthermore, the shape of the substrate and particularly the surface to be coated can be any part of an assembly or device manufactured by any of various methods, such as, without limitation, casting, molding, machining, extruding, welding, wrought, or otherwise fabricated. One preferred application contemplated herein is the coating of substrates that are automotive components such as wheels, bumpers and trim components or vehicle parts such as mirrors, step rails, valve covers, engine components, fans, grills, bumpers, body panels, brake components, brake calipers, wheels, rims, gas caps and covers, exterior bolts or fasteners, license plate holders, luggage racks, bump railing, grill covers, headlight and taillight covers, wenches, trailer hitches, interior components, shifters, gauges, handles, engine casings, hoses, tail pipes, vents, exhaust components, trim components, body panel railing, hood scoops or louvers, and the like. More preferably, the substrate is a steel or aluminum alloy wheel used in the automotive industry.

As used herein, “radiation-cured” refers to a process for curing a material or layer of material, as well as to compositions or materials cured or curable as described in this paragraph, wherein curing is initiated and caused to proceed through the introduction of or in response to some form of electromagnetic radiation. Herein it is preferred the electromagnetic radiation used to cure a radiation-cured composition or layer is ultraviolet radiation (“UV”). Alternatively, other wavelengths of electromagnetic radiation can be used based on selection of appropriate curing initiators, sometimes called photoinitiators, as is well understood in the art, for example radiation that is more or less energetic than ultraviolet radiation, typically X-rays or visible light. In addition, the radiation can be provided in a variety of forms, e.g. it can be supplied from appropriately filtered incandescent bulbs, electron beam radiation, lamps that emit radiation incident to an electrical discharge, such as the well known mercury discharge lamps for generating “UV” radiation, etc. For reasons that will become clear below, infrared radiation is undesirable to initiate curing of radiation-cured materials because infrared radiation transfers thermal energy in the form of heat, which it is desired to minimize during application of the radiation-cured layer as described below. A radiation-cured material or composition is not necessarily intended to imply that the composition or material excludes (i.e. will not also be cured via) other modes of cure or cross-linking initiation; e.g. heat. However, it is preferred such materials or compositions are not heat curable, or at least that in the methods disclosed herein they are not cured or cross-linked through the application of heat.

Metals used as substrates herein can include ferrous metals and non-ferrous metals, such as, without limitation, steel, iron, aluminum, zinc, magnesium, alloys and combinations thereof. In one embodiment, a metal substrate is formed from steel, aluminum, or aluminum alloys.

The term “overlies” and cognate terms such as “overlying” and the like, when referring to the relationship of one or a first, superjacent layer relative to another or a second, subjacent layer, means that the first layer partially or completely lies over the second layer. The first, superjacent layer overlying the second, subjacent layer may or may not be in contact with the subjacent layer; one or more additional layers may be positioned between respective first and second, or superjacent and subjacent, layers.

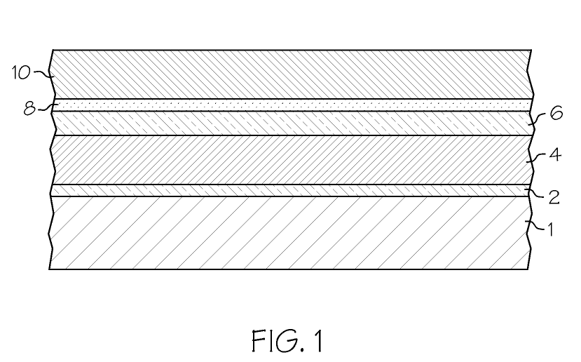

With reference to FIG. 1, there is shown a substrate 1 having a plurality of layers that comprise a preferred arrangement for applying a decorative metal layer 8 as discussed herein. The layer arrangement on the substrate 1 is as follows: pretreatment layer 2, leveling layer 4, radiation-cured layer 6, decorative metal layer 8 and a top coat layer 10. As seen in FIG. 1, the pretreatment layer 2 is applied onto and overlies the substrate 1, followed by the leveling layer 4 which overlies the pretreatment layer 2, the radiation-cured layer 6 which overlies the leveling layer 4, the decorative metal layer 8 which overlies the radiation-cured layer 6, and the top coat layer 10 which overlies the decorative metal layer 8. It is understood that the layer arrangement shown in FIG. 1 can include additional layers between or on top of the layers. Each of the layers described above and shown in FIG. 1, as well as methods for providing and depositing them, shall now be described.

The pretreatment layer 2 of FIG. 1 is an optional but preferred layer. It is applied to the surface of the substrate 1 to inhibit future oxidation of the substrate surface and to convert the substrate surface to a uniform, inert surface that improves the bonding of the superjacently applied layer, such as the leveling layer 4. Typically, a pretreatment layer 2 of this type is a conversion coating as known in the art. Conversion coating materials can include, but are not limited to, phosphate, iron, zinc, chromium, manganese, or combinations thereof, which can be applied via conventional techniques. For example, such coatings may be applied via conventional spray coating techniques at a temperature of 100 to 180° F. for 60 to 120 seconds. However, other conventional, well-known methods of application can be used to apply the pretreatment layer 2 of FIG. 1.

The leveling layer 4 is applied to the surface of the substrate 1, or pretreatment layer 2 if present, to provide a smooth, level surface for the deposition of the remaining superjacent layers. The leveling layer 4 significantly reduces the amount of mechanical surface preparation of the substrate 1 that will be required to ensure that surface defects will not show or be visible through the decorative metal layer 8 once it is deposited. It should be pointed out the leveling layer 4 is not necessarily considered to completely obviate or eliminate all mechanical surface preparation prior to depositing the decorative metal layer 8. Indeed, some mechanical treatment of either the substrate 1, or of the leveling layer 4 once it is applied and cured, may be desirable in particular applications. What is contemplated, however, is that the as-applied leveling layer 4 surface is or will be significantly smoother than the virgin substrate surface when applied overlying the substrate 1 or pretreatment layer 2, and if additional mechanical surface treatment is to be performed, such will be of considerably lesser degree and can be achieved with less abrasive or corrosive methods and materials than conventionally used.

For example, before applying a leveling layer 4, the substrate 1 is usually cooled to a low temperature, preferably to a temperature below the coalescing temperature of the leveling layer material to prevent premature sintering of the leveling layer 4, which often can cause a ripple or orange peel effect on the surface of the layer, thus requiring surface preparation before the decorative metal layer 8 is applied to the leveling layer 4. Furthermore, defects in the leveling layer 4 such as pin holes, can result if the substrate 1 is not heated prior to applying the leveling layer 4. Preferably, the substrate 1 is heated to 220 to 350° F. after the pretreatment layer 2 is applied to release any trapped gas before the substrate 1 and pretreatment layer 2 are cooled to ambient temperature for application of the leveling layer 4. If the pretreatment layer 2 is not applied, it is also preferred to heat the substrate 1 in a similar manner as described above before applying the leveling layer 4. Such defects should be reworked prior to depositing the decorative metal layer 8, but will require less rigorous, time, cost and labor intensive methods than conventional surface preparations for virgin substrates.

It is preferable that the leveling layer 4 is composed of a material that can be cured at a temperature of 275 to 375° F., and more preferably at 300 to 330° F. The leveling layer 4 can be deposited as a thermally-curable material, preferably a thermoset powder coating composition, that cures when exposed to heat, less preferably to a combination of heat and radiation. Powder coating compositions are comprised of a film forming material or binder as a main component and, optionally, a pigment. The amount of film forming material in the powder coating composition generally ranges from about 50% to 97% by weight of the powder coating composition. Acceptable film forming binder materials include but are not limited to epoxy resin, epoxy-polyester resin, polyester resin, acrylic resin, acryl-polyester resin, fluororesin and the like. Of those noted, an acrylic resin is preferable to provide superior anti-weathering capability and corrosion protection, as is required for automotive wheels. In addition, when thermosetting resins are used as the film forming material, a curing agent also is used. Suitable curing agents may be those known according to the functional group aligned and compatible with the thermosetting resin to be used to initiate and promote cross-linking thereof. Useful curing agents depending on the target functional groups include block isocyanate, aliphatic polycarboxylic acid, aliphatic anhydride, aminoplast resin, triglycidyl isocyanate, hydroxyalkylamide, phenol resin, polyisocyanates, polyacids, polyanhydrides, dodecanedioic acid and mixtures thereof. The amount of curing agent in the powder coating composition generally ranges from about 3% to 50%, by weight. Powder coating compositions can further comprise one or more pigments or other additives such as an ultraviolet absorber, rheology control agent, anti-oxidant, pigment dispersing agent, fluidizing agent, surface adjusting agent, foam inhibitor, plasticizer, charge inhibitor, surfactant or the like. In a preferred embodiment the average particle size of the powder coating particles is about 10 μm to 30 μm, preferably about 15 μm to 25 μm and more preferably about 18 μm.

It is preferred that the leveling layer 4 be product ACE-4119 as supplied by Seibert Powder Coatings, Cleveland, Ohio, which is a clear, colorless acrylic resin. Known properties of ACE-4119 include a 60° gloss value of greater than 90, specific gravity of about 1.11, a cure schedule of 25 minutes at 325° F. metal temperature, recommended film thickness of about 2.0 to 4.0 mm, pencil hardness value after cure of 2H and a minimum storage stability of 2 months at 35° C. Known alternatives to the product ACE-4119 include, but are not limited to, ACE-2253 that is also commercially available from Seibert Powder Coatings, which is also a clear, colorless acrylic resin.

The leveling layer 4 can be applied over the surface of the substrate 1 or of an intermediate layer, such as the pretreatment layer 2 if present, by any of the well-know and conventional methods such as electrostatic spraying, frictional electrification, spraying and fluidized bed.

The leveling layer 4 preferably is a thermally-cured layer that can be cured by any of the well-known and conventional heating methods. Preferably, the leveling layer 4 is pre-cured by heating the substrate 1 and leveling layer 4 from ambient temperature, at which the leveling layer 4 is initially deposited, to approximately 250 to 290° F. via a temperature rise rate of 30 to 80° F. per minute, and more preferably 40 to 60° F. per minute. It is preferred that the substrate 1 and leveling layer 4 be maintained at approximately 250 to 290° F. for 1 to 12 minutes, and more preferably at approximately 265 to 275° F. for 4 to 8 minutes. Subsequent to the pre-cure, the substrate 1 and leveling coat 4 are baked at a temperature of approximately 260 to 375° F. for a period of 10 to 45 minutes. It is preferred that the substrate 1 and leveling layer 4 are baked at approximately 290 to 325° F. for 25 to 35 minutes. Finally, the substrate 1 and leveling layer 4 are cooled to approximately 100 to 200° F., more preferably to approximately 140 to 170° F., prior to depositing the radiation-cured layer 6 described below.

Proper cure of the coating can be measured by a variety of methods known to the industry, such as Differential Scanning Calorimetry, multiple rub with methyl ethyl ketone, dye stain and pencil hardness.

The leveling layer 4 has a dry or cured thickness at least effective to significantly level out the surface of the substrate 1. Generally, this thickness is from 10 μm to 100 μm, preferably from 20 μm to 80 μm, more preferably from 30 μm to 75 μm and even more preferably from about 40 μm to about 65 μm.

The radiation-cured layer 6 of FIG. 1 is applied onto and overlies the leveling layer 4. The radiation-cured layer 6 provides a smooth, level surface to which the decorative metal layer 8 can be applied and further eliminates or reduces the need for additional surface treatment of the leveling layer 4. Applying the radiation-cured layer 6 over the leveling layer 4 can eliminate small surface defects, such as pinholes or fine scratches on the leveling layer 4. These small surface defects on the leveling layer 4 would otherwise be highlighted in the decorative metal layer 8 if not abated through surface treatment methods. As such, the radiation-cured layer 6 prevents and makes unnecessary further surface preparation of the leveling layer 4 to remove such defects. Additionally, the radiation-cured layer 6 provides a smooth, level surface that requires less energy and cure time than that necessary for a heat-cured layer.

The radiation-cured layer 6 provides a desirably smooth surface that exhibits excellent adhesion to the metal layer 8. Specifically, the radiation-cured layer 6 exhibits high surface tension in air once cured, which promotes increased adhesion with the decorative metal layer 8 applied thereto. Strong adhesion between the radiation-cured layer 6 and the decorative metal layer 8 provides significant durability to environmental conditions. Furthermore, the adhesion between these layers is sufficient to withstand subsequent heating in the coating process discussed herein, as well as high temperature applications. For example, it has been shown that adhesion between the preferred radiation-cured layer 6 described below and the decorative metal layer 8 is unaffected or substantially unaffected after being exposed to a temperature of 400° F. for 90 minutes.

Properties of the radiation-cured layer 6 that provide minimal visual defects to the decorative layer 8 include, but are not limited to, high surface density and uniform-smooth surface. More specifically, the high surface density of the radiation-cured layer 6 creates a surface with minimal cavities, ripples and pin holes, which otherwise would be visible in the decorative metal layer 8.

In addition to providing a high energy surface to facilitate decorative metal layer 8 adhesion thereto, it also is desirable that the radiation-cured layer 6 be provided with sufficient properties to provide a more uniformly flat, level surface for applying such layer 8 if necessary or desired. This can be achieved for example, by the pre-heating described below to further level out the radiation-cured layer 6 surface.

A preferred radiation-cured layer 6 is provided as a radiation-curable material, preferably an acrylated or methacrylated polyester urethane liquid, that is deposited on the subjacent (i.e. leveling) layer and then cured to provide the cured layer 6. Typically the radiation-cured layer 6 is comprised of a polymeric film forming material, a radiation sensitive monomer having polymerizable unsaturated bonds, a photopolymerization initiator, and an inert solvent vehicle. The material for the radiation-cured layer 6 should be chosen to produce or provide surface properties that are advantageous to receive a vapor deposited metal layer. For example, the preferred product, UVB22V1 available from Red Spot and further described below, has a unique receptivity to various metals. Both vapor deposited aluminum and chromium exhibit good adhesion to a UVB22V1 radiation-cured layer. Whereas, other radiation-cured materials often exhibit adequate adhesion to only a specific metal.

Conventional additives can be incorporated or added into the radiation-cured material layer 6 to impart desired properties thereto. Such additives may include, e.g., polymeric or silicone coating surface improvers, flow improvers, dyes, pigments, flattening agents, anti-foaming agents, light stabilizers and antioxidants, in varying amounts dependent upon desired function and performance of the final coating film. In the composition of the radiation-cured layer 6, it is important to consider that many conventional additives are not required and must be reviewed for any detrimental interference with the metal deposition process.

Suitable inert solvents include ethyl acetate, butyl acetate, acetone, methylisobutylketone, methylethylketone, butyl alcohol, isopropanol, toluene, xylene, or a mixture of solvent types.

In a preferred embodiment, the radiation-cured layer 6 material is the commercially available product UVB22V1, supplied by Red Spot Paint & Varnish Co., Inc, Evansville, Ind., which is a proprietary “UV” curable acrylated urethane liquid resin. Known properties of UVB22V1 include, but are not limited to, 58% weight by solids, density value of 8.4 lbs/gal, VOC value of 3.5 lbs/gal, water resistance to 40° C., heat resistance to 177° C. and thermal shock resistance to 90° C.

The product UVB22V1 is a proprietary composition that includes the components listed below in table 1, in the following weight percents based on information (i.e. MSDS and product data sheet) published by Red Spot.

TABLE 1

| Component | CAS Number | Weight % Less Than |
|---|---|---|
| Butyl Acetate | 123-86-4 | 30 |
| Multifunctional Acrylate | 15625-89-5 | 15 |
| Xylene | 1330-20-7 | 10 |
| Mineral Spirits | 8052-41-3 | 10 |
| Dipentaerythritol | 60506-81-2 | 5 |
| Monohydroxypenta-Acrylate | | |
| Photo Initiator | 24650-42-8 | 5 |
| Methyl N-Amyl Ketone | 110-43-0 | 5 |
| Ethyl Benzene | 100-41-4 | 5 |

Known alternatives to product UVB22V1 include, but are not limited to, UVB22, UVB510, UVB527 and UVB63, all of which are commercially available from Red Spot Paint & Varnish Co., Inc.

Application of the radiation-cured layer 6 can be accomplished by several techniques known to the industry, such as conventional air atomized spray, conventional air atomized spray with electrostatic charge, electrostatic rotary atomized application as well as others. It is preferred that electrostatic charge spraying is used for its desirable transfer efficiency and uniform thickness of the applied radiation-cured layer 6.

The radiation-cured layer 6 can be cured by irradiation with ultraviolet rays by conventional methods. Preferably, before the radiation-cured layer 6 is exposed to ultraviolet radiation, the layer 6 is heated to a temperature in the range of about 150 to 200° F., and more preferably of about 160 to 180° F. Such moderate or mild pre-heating of the radiation-cured layer 6 is advantageous to promote or cause the thick, viscous layer 6 to flow, thereby presenting a more uniformly flat, even surface. The pre-heating also allows the radiation-cured layer 6 to devolatize, i.e. to evaporate solvents from the layer 6 before it is cured. Heating of the radiation-cured layer 6 can be accomplished by conventional means, with the most preferred method being quartz heat lamps. Less preferably, low velocity filtered and heated air is used to pre-heat the radiation-cured layer 6. It is desirable to heat the radiation-cured layer 6 for a length of about 1 to 6 minutes. The radiation-cured layer 6 is then exposed to ultraviolet radiation for a period of 5 to 500 seconds, preferably 100 to 400 seconds and more preferably 140 to 240 seconds. The curing distance, the distance between the surface of the radiation-cured layer 6 and the radiation source, typically is about 4 to 20 inches, and more preferably about 6 to 12 inches.

Ultraviolet radiation sources having an emission wavelength of about 180 nm to about 450 nm are preferred. Ultraviolet sources include, but are not limited to, sunlight, mercury lamps, arc lamps, zenon lamps, gallium lamps. It is desirable to use high-pressure mercury vapor discharge lamps, which generate “UV” radiation incident to the mercury discharge, to cure the layer 6. High-pressure lamps of this type generally having intensities of 30 W/cm to 400 W/cm are most desirable. It is generally known that high-pressure lamps of this intensity range are capable of quickly exposing a substrate to about 75 to about 7,000 mJ/cm². It is preferred that an ultraviolet source chosen to cure the radiation-cured layer 6 is capable of producing 3,500 to 6,000 mJ/cm² within 5 to 500 seconds, preferably within 100 to 400 seconds and more preferably within 140 to 240 seconds.

The radiation-cured layer 6 has a dry or cured thickness preferably in the range from about 1 μm to about 100 μm, or from about 10 μm to about 100 μm. More preferably the layer 6 has thickness of from about 5 μm to about 75 μm, and more preferably from about 15 μm to about 25 μm.

The metal layer 8 of FIG. 1 is applied onto and overlies the radiation-cured layer 6 to provide a decorative or aesthetic appearance to the substrate 1. Preferably, the decorative metal layer 8 is applied over the radiation-cured layer 6 in atomized form. The decorative metal layer 8 can be applied via one of several techniques known to the industry, such as physical vapor deposition, chemical vapor deposition, magnetron sputtering and plasma deposition. Of these processes, physical vapor deposition is the most desirable in the present application. Each of these methods requires a target metal to be atomized, usually in a vacuum chamber, by electric charge, heating or pressurized inert gas. Atoms of the metal are carried to the surface onto which the atoms are to be deposited, and they are deposited thereon until a desired thickness is achieved. The decorative metal layer 8 adheres to the radiation-cured layer 6 as a decorative surface. A gas may be introduced during the metal depositing process in order to produce a desired color or aesthetic appearance to the metal layer 8. Gases such as argon, nitrogen, or the like or combinations thereof may be introduced in the metal depositing process. Gases or gas mixtures which produce colors such as black-gray, smoke, gun-metal or titanium are desirable. Metals suitable for depositing include, but are not limited to, metal alloys, titanium, copper, silver, gold, zirconium, platinum, SS, aluminum, nickel, chromium-nickel alloys, combinations thereof and alloys thereof.

The decorative metal layer 8 has a general thickness of 10 to 2,500 angstroms, preferably from 500 to 2,000 angstroms, and more preferably from about 1,000 to about 1,600 angstroms. In one embodiment, the decorative metal layer 8 has a thickness of about 1150 angstroms. The metal layer 8 is preferably deposited as a single layer directly onto the radiation-cured layer 6. The single metal layer 8 is preferably continuous and/or uninterrupted and directly adheres to the radiation-cured layer 6. The single metal layer 8 preferably does not contain channels, etchings or other voids which allow an overlying layer, such as an overlying top coat layer 10, to come into contact with the radiation-cured layer 6. Less preferably, multiple metal layers, one directly over another, can be used to provide a decorative metal layer 8.

The top coat layer 10 of FIG. 1 is applied onto and overlies the decorative metal layer 8 to prevent oxidation and environmental damage to the decorative metal layer 8. Preferably the composition of the top coat layer 10 is the same as that of the leveling layer 4. Thus, the method of applying the top coat layer 10 is or can be the same as that described above with respect to the leveling layer 4. Because the methods of applying the leveling layer 4 and the top coat layer 10 can be the same, risk of contamination of powders or other coating materials such as decorative particles or texture particles in the processing area is minimized. Furthermore, the same booth and application equipment can be used to apply both layers, thereby reducing equipment and labor costs associated with coating the substrate 1.

It is understood that although the preferred composition of the top coat layer 10 is the same as the leveling layer 4, alternative compositions of the top coat layer 10 can include, for example, all those referenced above for the leveling layer 4.

In one embodiment, the top coat layer 10 can be composed of a thermally-curable material. The layer 10 preferably has a cured thickness sufficient to protect the surface of an underlying layer such as a decorative metal layer 8, as well as other underlying layers and the substrate 1. For example, the cured top coat layer 10 can have a thickness of about 10 μm to 120 μm, 20 μm to 80 μm, 30 μm to 75 μm or about 40 μm to about 65 μm. The thermally-curable material can be a thermoset material, such as an acrylic resin that is clear and colorless after curing. Preferably, the curable material used to form the top coat layer 10 and the clear coat layer 16 discussed below is clear and colorless. The top coat layer 10 can be cured by any of the well-known and conventional heating methods discussed above with regard to the leveling layer 4.

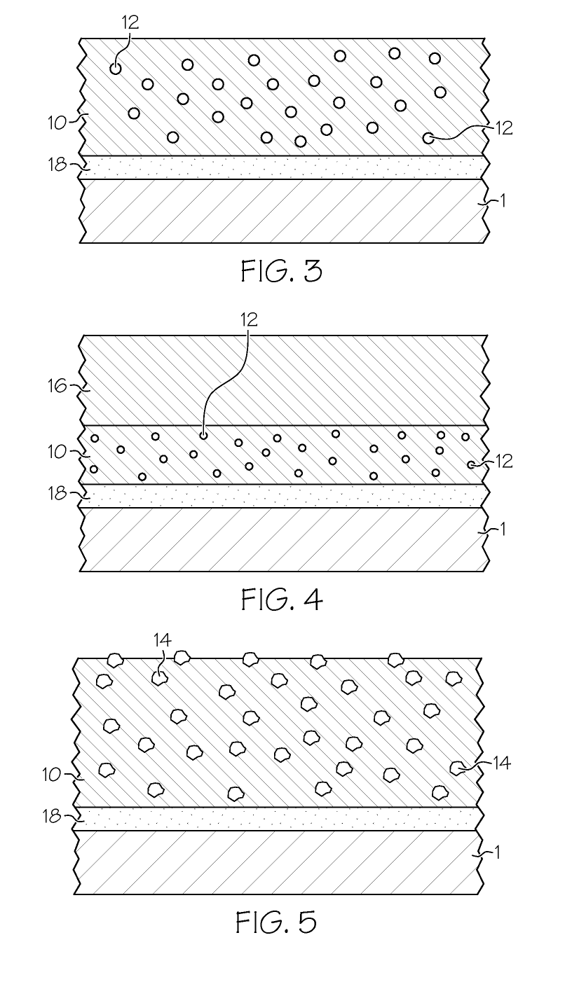

As shown in FIG. 3, the top coat layer 10 can have decorative particles 12 dispersed therein. The decorative particles 12 are capable of producing a specular brilliance that is desirable to automotive and other markets. Decorative particles 12 having different colors, shapes or sizes can be used to achieve a reflective or brilliant coating for displaying a select color combination. The decorative particles 12 might include, for example, mirror particles such as fractured or crushed mirror particles, glass particles such as fractured or crushed glass particles, beads, powder pigment particles, colored or clear glass particles, prisms, reflective material particles, metal flakes, mica particles, glitter particles, materials that sparkle and the like. The particles might include, for example, Helicone®, Xerilic, Iridin particles supplied by Wacker Chemie AG of Munich, Germany. The decorative particles 12 can be glass particles with trace amounts of copper, lead, silver, aluminum, calcium, boron, magnesium or combinations thereof. These particles 12 can be Chrome Brite CB particles, such as CB5000, CB4500, CB4000, CB2300, CB160 and CB100, provided by Bead Brite Glass Product Corporation of Coconut Creek, Fla. The Chrome Brite CB particles have refractive indices that create a brilliant and reflective aesthetic appearance by reflecting light at various angles within the top coat layer 10 and onto a layer underlying the top coat layer 10, such as a decorative metal layer 8. The Chrome Brite CB particles can be added to the top coat layer 10 with other decorative particles 12 such as those noted above to provide a sparkling and/or reflective aesthetic appearance to the top coat layer 10. The decorative particles 12 can have a particle size in the range of 1 to 100 microns, 1 to 45 microns or about 1 to about 15 microns.

Decorative particles 12 can be pre-mixed with uncured powder material, such as a thermoset material comprising an acrylic-based resin, in order to form a dry blend or powder mixture that can be applied over an intermediate layer 18, such as a decorative metal layer 8, as shown in FIG. 3. The pre-mixed decorative particles 12 and uncured powder material form a free-flowing powder that can be applied as an uncured dry, powder layer. A liquid medium, such as a volatile organic solvent, is not required during depositing of the top coat layer 10 over an underlying intermediate layer 18. Thus, harsh solvents that can be harmful to the environment are eliminated from the process of applying the top coat layer 10.

The weight ratio of decorative particles 12 to uncured powder material can be 1:99 to 99:1, or more preferably about 1:99 to about 20:80. The pre-mixed dry powder mixture can be applied over an underlying layer such as the decorative metal layer 8 by any of the well-known techniques described above, such as spraying, electrostatic spraying and frictional electrification. The top coat layer 10 can be cured at the conditions described with regard to the leveling layer 4 (e.g., 260 to 375° F. for a period of 10 to 45 minutes). Prior to curing, the top coat layer 10 containing dispersed decorative particles 12 can be pre-cured by heating the layer 10 from ambient temperature, at which it is deposited, to approximately 250 to 290° F. via a temperature rise rate of 30 to 80° F. per minute, and more preferably 40 to 60° F. per minute. It is preferred that the top coat layer 10 be maintained at approximately 250 to 290° F. for 1 to 12 minutes, and more preferably at approximately 265 to 275° F. for 4 to 8 minutes. Subsequent to the pre-cure step, the top coat layer 10 is baked at a temperature of approximately 260 to 375° F. for a period of 10 to 45 minutes. It is preferred that the top coat layer 10 is baked at approximately 290 to 325° F. for 25 to 35 minutes. Finally, the top coat layer 10 is cooled to approximately 100 to 200° F., more preferably to approximately 140 to 170° F. The top coat layer 10 comprising the decorative particles 12 can have a cured thickness of 10 to 120 microns, 20 to 80 microns, 30 to 75 microns or about 65 microns.

The decorative particles 12 can be added to the curable material forming the top coat layer 10 in order to alter the surface texture of the top coat layer 10 or enhance the surface durability of the top coat layer 10. For example, if decorative particles 12, such as glass beads or particles are present at the surface of the cured top coat layer 10, the layer 10 will be more scratch resistant because less cured resin is exposed at the surface. Although not shown, in this arrangement the glass beads can sit on the surface of the cured top coat layer 10 and share surface space with the cured resin material. Surface portions of the top coat layer 10 comprising cured resin are generally scratch prone and can become marred. By occupying a portion of the surface of the top coat layer 10, the decorative particles 12 can reduce the surface area prone to scratching (i.e. the surface area occupied by the cured resin). The inclusion of decorative particles 12 in the top coat layer 10 can enhance the surface durability of the cured layer 10 against scratch and mar and provide repulsion to surface dirt or film build-up on the layer 10. The decorative particles 12 can occupy greater than 1, 5, 10, 15, 20, 25, 30 or 35 percent of the surface area of the top coat layer 10.

The decorative particles 12 can alter the aesthetic gloss appearance of cured material at the surface of the top coat layer 10. The decorative particles 12 protruding from and/or sitting on or near the surface of the top coat layer 10 can provide sparkle to the layer 10 and resist wearing over time such that the cured resin forming the surface between the decorative particles 12 does not shine or become polished over time. Generally, cured powder resins, such as an acrylic-based resin, can become shiny or develop a polished appearance over time because the surface is rubbed, brushed or in contact with a user (i.e. touched) or another surface rubs against the cured resin. Continued wear or rubbing polishes the surface of the cured resin and causes it to shine or have some sort of glean. Adding decorative particles 12 to the composition forming the thermally-curable top coat layer 10 can reduce the amount of shine developed on the surface of the layer 10 over time. Further, inclusion of decorative particles 12, such as the Chrome Brite CB particles, can enhance the thermal characteristics of the top coat layer 10. For instance, heat build up in the top coat layer 10 can be reduced by about 100 to 30° F. depending on the inherent characteristics of the resin powder used and the amount of decorative particles used. It is thought that the particles reflect light and heat away from the top coat layer and underlying layers.

As shown in FIGS. 3-5, the top coat layer 10 can overlie an intermediate layer 18. The intermediate layer 18 might include, for example, a decorative metal layer 8, a radiation-cured layer 6, a leveling layer 4, a pretreatment layer 2 or combinations thereof. Although not shown, the intermediate layer 18 can comprise a combination of distinct layers that overlie the substrate 1. For example, the layered structure of the present invention might include a substrate 1 having a plurality of overlying layers comprising an arrangement on the substrate 1 as follows: pretreatment layer 2, leveling layer 4, radiation-cured layer 6, decorative metal layer 8, top coat layer 10 and clear coat layer 16. It is understood that the layer arrangement shown in FIGS. 3-5 can include additional layers between or on top of the layers.

In another embodiment, the top coat layer 10 can comprise texture particles 14 dispersed therein. The texture particles 14 can provide a rough or uneven surface to the top coat layer 10. FIG. 5 shows a top coat layer 10 having texture particles 14 dispersed throughout and extending above the surface. A rough surface advantageously gives the layer 10 desirable features such as a non-slip, durable surface or an aesthetic textured appearance. As shown, the texture particles 14 can extend above the surface of the top coat layer 10 such that the texture particles 14 occupy a portion of the surface. Generally, the remaining portion of the top coat layer 10 surface not occupied by the texture particles 14 is composed of cured material, such as thermally-cured acrylic resin. The texture particles 14 can occupy greater than 1, 5, 10, 15, 20, 25, 30 or 35 percent of the surface area of the top coat layer 10.

The texture particles 14 can provide impact resistance or add “give” to the top coat layer 10. Texture particles 14 can add flexibility to a top coat layer 10 and allow the layer 10 to compress or partially absorb the energy of an impact. The level of impact resistance the texture particles 14 provide depends on the inherent characteristics of the curable powder material used to form the top coat layer 10 and the amount of texture particles 14 utilized. For example, the inherent flexibility of the thermally-curable material used in the top coat layer 10 can itself provide impact protection. Curable powder material used to form the top coat layer 10 can provide a variety of coating hardnesses. An acrylic resin can provide a harder coating than a polyester resin. Thus, if an acrylic resin (i.e. a hard resin) were chosen, the texture particles 14 would tend to provide more impact resistance because the resin itself would tend not to compress and absorb the force of an impact. Adding texture particles 14 to a hard resin can create a very durable coating that can withstand abrasive or harsh conditions. On the other hand, if a polyester resin (i.e. a soft resin) were chosen, the texture particles 14 would provide less impact resistance because the cured polyester coating would be inherently softer than a cured acrylic coating.

The texture particles 14 can be various grades and forms of rubber, cork, and the like. Rubber particles might be composed of, for example, natural, recycled or non-recycled material. The texture particles 14 can have a particle size in the range of 10 to 500 microns, 20 to 200 microns or 50 to 150 microns. The texture particles 14 can be Rubber Tech particles provided by the Bead Brite/Rubber Tech Production Corporation of Coconut Creek, Fla. The texture particles 14 can be of any color such that the texture particles can compliment or color-match the thermally-curable powder material used to form the top coat layer 10. Alternatively, the texture particles 14 can be mismatched to the thermally-curable powder material in order to produce a two-tone affect to the top coat layer 10. The texture particles 14 can be added in any ratio to the uncured powder material to provide an unlimited number of color variations and texture combinations in the top coat layer 10. Further, the texture particles 14 can be any shape so that the texture affect and surface roughness of the layer 10 can be varied depending on the size, shape and ratio of texture particles 14 that are used in the layer 10.

The texture particles 14 can be pre-mixed with an uncured powder material used to form the top coat layer 10 to form a dry blend or powder mixture that can be applied over an intermediate layer 18. The weight ratio of texture particles 14 to the uncured powder top coat composition can be 1:99 to 99:1. The weight ratio is preferably about 1:99 to about 20:80. The pre-mixed powder mixture can be applied over an intermediate layer 18 by any of the well-known techniques described above such as spraying, electrostatic spraying and frictional electrification. The top coat layer 10 can be baked and/or pre-cured at the conditions described with regard to the leveling layer 4 (e.g., 260 to 375° F. for a period of 10 to 45 minutes). The top coat layer 10 comprising the texture particles 14 can have a cured thickness of 10 to 1000 microns, 50 to 800 microns or about 100 to 500 microns. Alternatively, the texture particles 14 can be added to the top coat layer 10 by the two-step process discussed below. In this case, the texture particles 14 would not be exposed on the surface of the top coat layer 10 and rather the texture particles 14 would be concentrated at or near the surface of the underlying intermediate layer 18. By being stratified in the top coat layer 10, the texture particles 14 can be positioned such that the particles 14 are not in contact with the underlying intermediated layer 18. Because the texture particles 14 generally have a larger particle size as compared to the decorative particles 12, the thickness of the top coat layer 10 and the clear coat layer 16 can be altered to accommodate the larger size of the texture particles 14. For example, the thickness of the top coat layer 10 can be 20 to 750 microns, 50 to 500 microns or 100 to 400 microns and the thickness of the clear coat layer 16 can be 5 to 200 microns, 10 to 100 microns or 15 to 50 microns.

In another embodiment (not shown), the top coat layer 10 can comprise decorative particles 12 and texture particles 14 dispersed therein. Both the decorative particles 12 and texture particles 14 can be pre-mixed with an uncured powder material used to form the top coat layer 10 in order to form a dry blend or powder mixture that can be applied to an intermediate layer 18 such as a decorative metal layer 8. The pre-mixed powder composition can be applied in dry form over an intermediate layer 18 by any of the well-known techniques described above such as spraying, electrostatic spraying and frictional electrification. The top coat layer 10 can be cured and/or pre-cured at the conditions described with regard to the leveling layer 4 (e.g., 260 to 375° F. for a period of 10 to 45 minutes). The weight ratio of texture particles 14 and decorative particles 12 to the uncured powder top coat composition can be 1:1:98, 1:98:1 or 98:1:1. The weight ratio is preferably 1:1:98 to 1:20:79 or 1:1:98 to 20:1:79. The decorative particles 12 and texture particles 14 can be arranged in the top coat layer 10 such that the particles 12, 14 do not extend above the surface of the top coat layer 10. In this arrangement, the surface of the top coat layer 10 is smooth and uninterrupted. Alternatively, the decorative particles 12, texture particles 14 or a combination thereof can be located near the surface of the top coat layer 10 or extend or protrude above the surface of the layer 10. The decorative particles 12 and/or texture particles 14 sitting on the surface can occupy greater than 1, 5, 10, 15, 20, 25, 30 or 35 percent of the surface area of the top coat layer 10.

The decorative particles 12 and/or texture particles 14 can be added to the top coat layer 10 by a two-step process discussed below. The two-step method comprises applying the top coat layer 10 and a clear coat layer 16. The clear coat layer 16 overlies the top coat layer 10. The two-step method ensures that the decorative particles 12 and/or texture particles 14 are concentrated near the underlying intermediate layer 18 as shown in FIG. 4. As discussed above, the texture particles 14 can be larger than the decorative particles 12. Thus, if texture particles 14 are used, the top coat layer 10 can be 5 to 750 microns, 50 to 500 microns or 100 to 400 microns. The thickness of the clear coat layer 16 can be 5 to 200 microns, 10 to 100 microns or 15 to 50 microns. In total, the thickness of both layers (10 and 16) can be 10 to 1000 microns, 50 to 800 microns or about 100 to 500 microns.

In another embodiment, a clear coat layer 16 can overlie the thermally-curable top coat layer 10 comprising decorative particles 12. The preferred composition of the clear coat layer 16 is substantially the same as the leveling layer 4 and/or the top coat layer 10. That is, the thermally-curable material of the clear coat layer 16 is preferably clear and colorless once cured. Alternatively, the clear coat layer 16 composition can be any thermally-curable material, such as all those referenced above for the leveling layer 4. Although not preferred, the clear coat layer 16 can comprise decorative particles 12, texture particles 14, or combinations thereof. Being free of particles 12, 14, the clear coat layer 16 can generally provide protection against environmental damage or wear of the top coat layer 10 and/or any particles 12, 14 dispersed therein.

The top coat layer 10 and clear coat layer 16 can be applied over a substrate 1 in a two-step process. The two-step process comprises providing a substrate having at least one intermediate layer 18 overlying the substrate. Optionally, a thermally-cured leveling layer 4 can be located between the substrate and the intermediate layer 18. The top coat layer 10, comprising particles dispersed therein, such as decorative 12 or texture particles 14, and a thermally-curable material, is deposited over the at least one intermediate layer 18. The clear coat layer 16 is applied over the top coat layer 10. The clear coat layer 16 comprises a thermally-curable material, and preferably substantially the same thermally-curable material used in the top coat layer. The clear coat layer 16 preferably does not comprise decorative particles 12 or texture particles 14. FIG. 4 illustrates the top coat layer 10 overlying an intermediate layer 18 and the clear coat layer 16 overlying the top coat layer 10. As shown, decorative particles 12 reside in the top coat layer 10, which is in direct contact with the underlying intermediate layer, such as a decorative metal layer 8.

The first step of the above-noted two-step process comprises pre-mixing particles selected from decorative particles 12, texture particles 14, or a blend of multiple types of decorative particles 12 or texture particles 14, or combinations thereof with an uncured powder material, such as an acrylic resin, in order to form a dry powder blend that is used to form the top coat layer 10. The uncured powder material is preferably substantially the same powder used to form the base leveling layer 4 and/or the uncured powder material used to form the clear coat layer 16 described below in step two. Using substantially the same uncured powder material in both steps (i.e. the two-step process described herein) provides a homogenous chemistry throughout the top coat layer 10 and the clear coat layer 16. The weight ratio of decorative particles 12 to the uncured powder material in the top coat layer 10 can be 1:99 to 99:1, 1:99 to 20:80, 5:95 to 15:85, or about 10:90. The dry powder blend of the first step can be applied over the intermediate layer 18 that will underlie the top coat layer 10, such as the decorative metal layer 8, by any conventional method known in the industry, such as those described herein.

The top coat layer 10 overlying the intermediate layer 18 can be pre-flowed or melted by heating the uncured dry powder blend from ambient temperature, 77° F. (25° C.), at which the dry powder blend can generally be applied, to approximately 200° F. The top coat layer 10 can be maintained at about 200° F. for a period of 5 to 10 minutes in order to allow the dry powder blend to flow or gel together. Preferably, the uncured powder material used in the dry powder blend begins to flow or melt at approximately 200° F. Pre-flowing the top coat layer 10 creates a smooth and level surface to which the clear coat layer 16 can be applied. Pre-flowing the top coat layer 10 stratifies the dispersed decorative particles 12 therein and keeps the decorative particles 12 from migrating or moving into the clear coat layer 16. That is, the decorative particles 12 reside substantially in the top coat layer 10. The stratification of the top coat layer 10 preferably provides a smooth surface that is substantially free of penetration by the decorative particles 12. The cured thickness of the top coat layer 10 can be 5 to 50 microns, 10 to 40 microns or about 15 to 25 microns.

The second step of the two-step process comprises applying uncured powder material, without decorative particles 12 mixed therein, over the pre-flowed top coat layer 10. The uncured powder material forms the clear coat layer 10 and can be applied over the pre-flowed top coat layer 10 by any conventional method known in the industry. The uncured powder material of the clear coat layer 16 and the pre-flowed top coat layer 10 can be baked at a temperature of approximately 260 to 375° F. for a period of 10 to 45 minutes in order to cure both layers (10 and 16). Preferably, the top coat layer 10 and the clear coat layer 16 are baked at 290 to 325° F. for 25 to 35 minutes. Both layers (10 and 16) are cured together during the baking period and thus tend to flow together to form a uniform and continuous layer. In this regard, if the same thermally-curable material is used to form the top coat layer 10 and clear coat layer 16, the layers 10, 16 can form a single, uniform layer without a distinct boundary between the layers 10, 16. As a single, uniform layer, the particles dispersed therein are concentrated and positioned near the bottom of the single layer.

Once cured, the top coat layer 10 and clear coat layer 16 are cooled from the curing temperature, for example 325° F., to a temperature of approximately 100 to 200° F. The clear coat layer 16 can have a cured thickness of 5 to 50 microns, 10 to 50 microns or about 15 to 50 microns. The top coat layer 10 and the clear coat layer 16 combined can have a cured thickness of 10 to 120 microns, 20 to 80 microns, 30 to 75 microns, or about 40 to 65 microns.

By adding a clear coat layer 16 over the top coat layer 10, the top coat layer 10 comprising the decorative particles 12 is positioned directly above the intermediate layer 18 such that the decorative particles 12 can reflect light against the intermediate layer 18 more brilliantly. Depending on the type decorative particles 12 used and the color or characteristics of the intermediate layer 18 positioned underneath, there are virtually an unlimited number of combinations of aesthetic finishes that can be created with the layers and materials described herein. Alternatively, the top coat layer 10 comprising the decorative particles 12 can be applied over a solid color base layer such as a paint layer and the like. The decorative particles 12 of the top coat layer 10 provide a multi-toned and/or sparkling finish to the coated substrate without the need of liquid coating compositions traditionally employed in the industry.

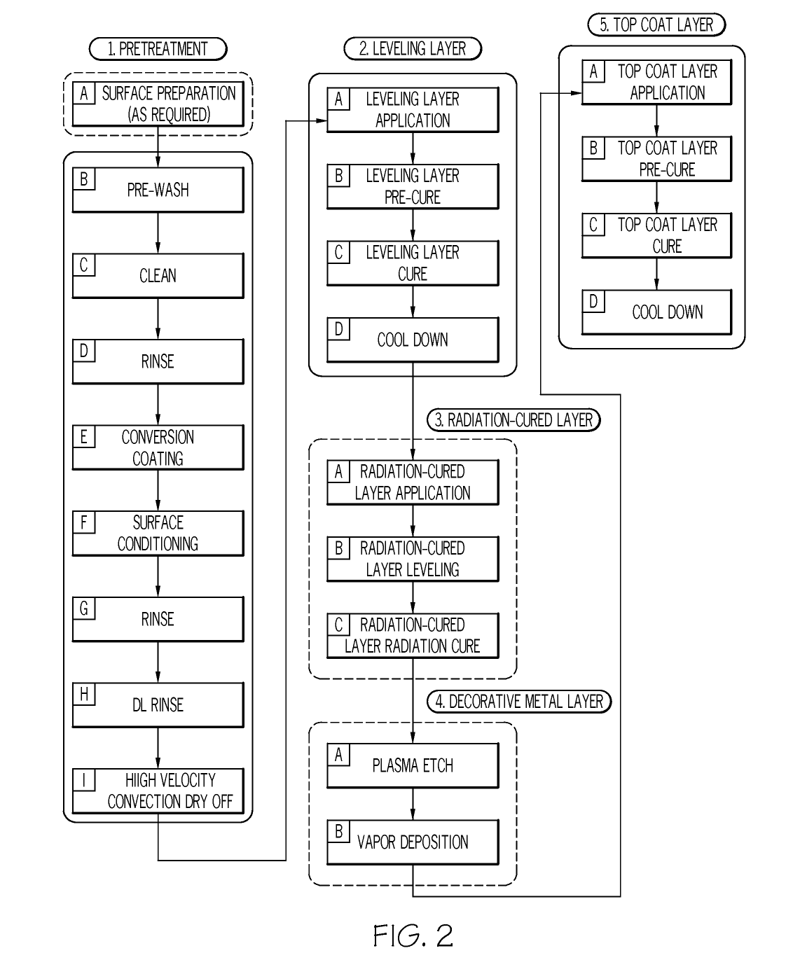

FIG. 2 shows a top level diagram for a process of applying a decorative metal layer to a substrate according to an embodiment of the invention. As seen from the diagram, the five principal stages for such a process are 1) cleaning or pretreatment of the substrate; 2) applying a leveling layer onto and overlying the substrate; 3) applying a radiation-cured layer onto and overlying the leveling layer; 4) applying a decorative metal layer onto and overlying the radiation-cured layer; and 5) applying a top coat layer onto and overlying the decorative metal layer. As will be evident from the figure, each of these stages includes or incorporates a number of steps. Steps illustrated in FIG. 2, which are not discussed hereinabove, are considered to be conventional and well known to persons having ordinary skill in the art, and for that reason are not discussed in further detail herein. It is considered that an important aspect of the present invention is the provision and deposition of the radiation-cured layer, stage (3) referred to above, and steps incident to this stage are outlined in broken lines in FIG. 2 and have been described in detail hereinabove.

The process shown in FIG. 2 is suitable for applying layers to a substrate in a batch or continuous manner, or a combination thereof. For example, in a batch process, the substrate is stationary during each stage of the process. In contrast, the substrate in a continuous process would move along a conveyor line.

### EXAMPLES

In order to promote a further understanding of the coating process and preferred embodiments thereof, the following examples are provided. It is understood that these examples are shown by way of illustration and not limitation.

### Example 1

An aluminum automotive wheel rim was coated utilizing the multi-layer coating of the present invention. The rim was first cleaned and degreased with KLEEN SNC110, DEOX 575MU and Permatreat 830MU cleaners supplied by GE Water Technologies. After degreasing, the rim was rinsed with deionized water to remove residual cleaner. The rim was further dried in a convection oven at a temperature of 350° F. for 10 minutes to provide a dry, clean surface for the subsequent layers. After drying, the rim was powder coated with ACE-4119 acrylic resin supplied by Seibert and baked at 260° F. for 6 minutes to pre-cure the ACE-4119 powder. The ACE-4119 powder was further baked at 325° F. for 30 minutes to produce a smooth surface and cure the leveling layer. The measured thickness of the cured ACE-4119 layer was 63 microns. The rim then was cooled to 140° F. and then spray coated with the radiation-curable product, UVB22V1 supplied by Red Spot. The UVB22V1 layer was pre-heated with quartz infrared heat lamps to a temperature of 175° F. for a period of 3 minutes to let the thick, viscous layer flow to flat. The UVB22V1 layer was then exposed to ultraviolet radiation for 2 minutes at a distance of 12 inches from high-pressure mercury discharge lamps that produced a radiation intensity of 6,500 mJ/cm². The measured thickness of the cured UVB22V1 layer was 25 microns. Pure chromium then was deposited onto the surface of the cured UVB22V1 layer (radiation-cured layer) by means of physical vapor deposition in a vacuum chamber to produce a decorative metallic appearance. The measured thickness of the deposited chromium layer was approximately 1150 angstroms. Following the application of this decorative metal layer, a top coat layer comprising the same material as the leveling layer, ACE-4119 powder, was powder coated over the decorative metal layer and then pre-cured at 260° F. for 6 minutes and further cured at 300° F. for 30 minutes. The measured thickness of the cured ACE-4119 top layer was 58 microns. The finished automotive rim displayed a polished, chrome appearance. The adhesion between the chrome metal layer and the UVB22V1 radiation-cured layer exhibited no perceptible defects after the rim was exposed to a temperature of 350° F. for 90 minutes.

### Example 2

There is a need for a method of applying a decorative metal layer to a substrate that provides good adhesion of the decorative metal layer to the substrate or underlying layers, such as a pretreatment, leveling or radiation-cured layer. As such, a test panel processed according to the procedure of Example 1 was tested for adhesion of the chromium layer to the radiation-cured UVB22V1 layer in the following manner. The test panel of this example, as well as those in the examples described below, consisted of a 4″×8″ aluminum panel with a leveling layer (ACE-4119), radiation-cured layer (UVB22V1), decorative metal layer (chromium) and a top coat layer (ACE-4119), unless otherwise specifically indicated. The process used to create the multi-layer coated test panel was the same as that described in Example 1, and thus the individual thickness for each deposited layer was approximately the same as the corresponding values (i.e. microns and angstroms) described above in Example 1.

The test panel was cross hatch cut as follows. A carbide-tipped knife was used to slice through the multi-layered structure deposited atop the underlying substrate to provide a cross hatch or grid pattern of regular congruent squares. The cutting was performed through all of the superjacently applied layers but did not penetrate the underlying substrate, which care was taken not to mark or score with the knife when cutting. To make the grid pattern, the knife was inserted straight downward (i.e. at a 90° angle relative to the surface of the topmost layer) toward the substrate, and then drawn laterally to make each of the linear cuts which were approximately 20 mm in length. The grid pattern consisted of a first set of 6 cuts parallel to one another and another set of 6 cuts parallel to each other and perpendicular to the first set, thereby resulting in a cross pattern. The parallel cuts were made approximately 2 mm apart. The method of cutting the cross hatch pattern described above resulted in 2 mm×2 mm squares on the surface of the substrate. The cut area (i.e. the cross hatch area of squares) of the test panel was brushed to remove any debris or flakes. Adhesion tape, having a 180-degree peel value to steel of at least 430 N/m, was placed over the cut area of the test panel so that the entire cross hatch pattern was covered. The tape was pressed firmly against the test panel for 10 seconds then removed with a rapid, upward motion. Upon removal of the tape, it was observed that none of the cross hatch squares were removed from the substrate surface. Furthermore, no other visible defects or peeling along the edges of the grid squares were observed. For example, the corner portions of the 2 mm×2 mm squares of the cross hatch area did not peel back or display signs of separation from the substrate. Furthermore, the internal layers of each 2 mm×2 mm square of the cross hatch area did not separate from one another. That is, the ACE-4119 layer, UVB22V1 layer, chromium layer and the top ACE-4119 layer did not separate or display visible signs of adhesion loss after the tape was removed or on removal of the tape.

### Example 3

A test panel processed according to the procedure of Example 1 was tested for humidity resistance in the following manner. The test panel was exposed to 100% relative humidity at approximately 38° C. with condensation on the test panel during the entire test period. The test panel was exposed to the above referenced conditions for a period of 96 hours and then for an additional 240 hours. Deionized water was used to produce the water vapor in the testing apparatus. The apparatus in which the test panel was placed was designed so that no condensation on the walls or roof of the apparatus was allowed to drip onto the test panel. After 96 hours, the test panel was removed from the test apparatus, dried and inspected for defects. No defects on the test panel were observed after it was dried. There were no signs of peeling, bubbling, blistering or cracking of the layers. After the test panel was placed in the apparatus for an additional 240 hours at the conditions described above, and then subsequently removed and dried, no defects were observed on the test panel. Similarly, no signs of peeling, bubbling, blistering or cracking were observed as well.

### Example 4

A test panel processed according to the procedure of Example 1 was tested for salt spray resistance in the following manner. The only difference from the material and layer arrangement of the test panel described in Example 2 was that here the decorative metal layer was a chromium-nickel alloy as opposed to the chromium metal layer of Example 2. The test panel was first scribed with a 2 inch long cut using a straight shank, tungsten carbide tip, lathe tool. The cut was made perpendicular (i.e. straight-down at a 90° angle) to the surface of the substrate, as opposed to being cut at an angle less than 90° with regard to the surface of the substrate. The lathe tool was mounted in a scribing fixture to make the straight scribe cut on the test panel. The scribe cuts, as discussed herein, were never made with a free-hand method. The scribe cut was tested with a multimeter to confirm end-to-end electrical continuity. The depth of the cut penetrated through all the layers on the surface of the substrate, but did not significantly pierce the surface of the substrate.

The test panel was then exposed, in a closed chamber, to a continuous fog of salt water. The chamber in which the test panel was placed was designed so that no condensation on the walls or roof of the chamber was allowed to drip onto the test panel. The chamber was maintained at approximately 35° C. during the entire testing period of 1000 hours. The salt-water solution used during the test was prepared by dissolving approximately 5 grams of salt (NaCl) per 95 ml of water. The salt-water solution had a specific gravity range of 1.0255 to 1.0400 at 25° C. and a pH range of 6.5 to 7.2. After the test panel was removed from the chamber, no visible signs of corrosion were observed on the surface of the test panel and only mild signs of corrosion less than 2 mm from the edge of the scribed cut were visible. It was also observed that there was no more than 3 mm of creep back from edges of the scribe cut, and no other loss of adhesion after air was used to blow out the scribe cut. To blow out the scribe cut, a high-pressure nozzle ejecting ambient air was placed in the cut and rapidly moved from side to side along the length of the cut.

### Example 5

Two wheel sections processed according to the procedure of Example 1 were tested for chip resistance in the following manner. Both sections were exposed to gravel being ejected by a gravelometer. The type of gravelometer used was model QJR manufactured by Q-Panel of Cleveland, Ohio. The air pressure used to operate the gravelometer was maintained at approximately 70 psi and the gravel used had an average diameter of approximately 9.5 mm to 16 mm. Two pints of gravel were poured into the gravelometer for a period of 15 seconds. Before testing for chip resistance, the first wheel section was maintained at a temperature of 25° C., whereas the second wheel section was maintained at −30° C. for 4 hours. The first section was exposed to gravel ejected from the gravelometer at approximately 25° C. The second section was removed from the freezer and tested at approximately −30° C. After testing, the wheel sections were allowed to equilibrate to 25° C. Conventional masking tape was used to remove any loose chips or debris on the surface of the sections. The wheel section tested at 25° C. exhibited chipping resistance equal to or better than a rating of 8 based on the well-known General Motors Corp. GM9508P Chip Resistance of Coating test scale, which is commonly used in the industry. The wheel tested at −30° C. exhibited chipping resistance equal or better than a rating of 7 on that scale.

### Example 6

Two test panels manufactured according to the procedure of Example 1 were tested for etching distortion and discoloration from exposure to severe environmental conditions in the following manner. Multiple drops of 10% by weight sulfuric acid in water solution of pH 3.0, 0.75% by weight calcium sulfate in water solution of pH 4.0, deionized water and tap water were placed on the surface of the first test panel. The first test panel was heated to a temperature of 80° C. from 25° C. within a period of 2 minutes, and maintained at 80° C. for a period of 30 minutes. After 30 minutes the drops were rinsed off of the first test panel with deionized water and the test panel was allowed to equilibrate to 25° C. After the first test panel reached 25° C., there were no visible no changes or defects on the surface of the top ACE-4119 layer. There was also no discoloration of the top ACE-4119 layer.

Two drops of each test solution referenced above were placed on the surface of the second test panel. The panel was aged at room temperature, approximately 25° C., for 24 hours at a relative humidity of 50%. After 24 hours, the drops were rinsed off the second test panel with deionized water and the panel was dried. Upon observation, no visible defects, surface changes, or discoloration was observed.

### Example 7

Two test panels manufactured according to the procedure of Example 1 were tested for solvent resistance in the following manner. After 72 hours from the time the first test panel was manufactured, it was submerged separately in a commercial wheel cleaner as is commonly used in public carwash facilities for a period of 24 hours. After a 24-hour period, the first panel was removed from the cleaner solution and rinsed with deionized water before being dried. After each removal, there was no visible degradation on the surface of the top ACE-4119 layer. Furthermore, the top ACE-4119 layer had a pencil hardness test value of 2H before and after the test.

The testing procedure used on the second test panel was to determine the top ACE-4119 layer's relative resistance to crazing caused by exposure to tire and wheel cleaners. One drop of isopropyl alcohol was placed on the surface of the second test panel at a temperature of 25° C. after it was allowed to stand for 72 hours after manufacture. Observation of the top ACE-4119 surface began as soon as the drop was placed. The isopropyl alcohol drop was allowed to sit on the surface of the second test panel for 1 minute. After 1 minute, it was rinsed off with deionized water. No visible signs of cracking or degradation of the surface of the test panel were observed.

### Example 8

A test panel manufactured according to the procedure of Example 1 was tested for outdoor weathering resistance in the following manner. The test panel was exposed to Southern Florida weather for a period of one year. The test panel was placed at a 5° angle from horizontal, facing South, in an outside environment receiving full exposure to sunlight. Southern Florida was chosen for its high humidity, high temperature and high incidence of radiant energy. The test panel was thoroughly washed with a mild liquid detergent, such as Ivory dish soap, before being placed outside. Once each month of the 12-month test period the test panel was cleaned with deionized water so clear observations of the substrate surface could be made. All of the one-months observations indicated no decrease in gloss, color change and surface cracking. The observations were made by comparing a portion of the panel unexposed to the sunlight to a portion that was exposed. A portion of the test panel was covered by the support flap or band that holds the test panel in position, thereby avoiding exposure to sunlight of said portion. After the 12-month test period, no visual reduction in gloss or change in color was observed on the surface of the test panel. Additionally, no surface cracking or blistering were visually detectable.

### Example 9

A test panel manufactured according to the procedure of Example 1 was tested for copper-accelerated acetic acid salt spray resistance in the following manner. The only difference from the material and layer arrangement of the test panel described in Example 2 was that here the decorative metal layer was a chromium-nickel alloy as opposed to the chromium metal layer of Example 2. The test panel was first scribed using the method described in Example 4. The test panel was then exposed, in a closed chamber, to a continuous fog of copper-accelerated acetic acid salt spray (CASS). The chamber in which the test panel was placed was designed so that no condensation on the walls or roof of the chamber was allowed to drip onto the test panel. The chamber was maintained at approximately 49° C. during the entire testing period of 168 hours. The CASS solution used during the test was prepared by dissolving approximately 1 gram of cupric chloride (CuCl₂ 2H₂O) per 1 gallon of water, then approximately 5-6 ml of glacial acetic acid was added. The CASS solution had a specific gravity range of 1.0255 to 1.0400 at 25° C. and a pH range of 3.1 to 3.3. After the test panel was removed from the chamber, no visible signs of corrosion were observed on the surface of the test panel or within the scribed cut. It was also observed that there was no more than 3 mm of creep back from edges of the scribe cut, and no other loss of adhesion after air was used to blow out the scribe cut. To blow out the scribe cut, a high-pressure nozzle ejecting ambient air was placed in the cut and rapidly moved from side to side along the length of the cut.

### Example 10

Four test panels manufactured according to the procedure of Example 1 were tested for thermal shock resistance in the following manner. Each of the four test panels contained a specific metal layer in which the first, second, third and fourth test panels contained an aluminum, nickel, chromium and chromium-nickel alloy metal layer, respectively. Each test panel was first submerged in a water tank for 3 hours at a temperature of approximately 38° C. The water was maintained at a maximum of 5 ppm salt (NaCl) during the 3 hour test period. The water was also aerated by placing a ¼″ plastic tube at the bottom of the tank to generate at a minimum one bubble per second. After 3 hours, the test panels were removed from the water bath and immediately placed in a freezer at a temperature of approximately −29° C. The test panels remained in the freezer for a period of 3 hours before being removed. Once the test panels were removed from the freezer, an “X” was scribed on the surface of the substrate using the method described in Example 4. After the “X” was scribed, within 60 seconds from freezer removal, low-pressure saturated steam at approximately 6 psi was blown from a steam generator nozzle for a period of 1 minute directly on the scribed “X” at a 45° angle. The steam nozzle was approximately 50 to 75 mm in distance from the scribed “X”.

In each of the test panels no visual signs of defects in the layer adhesion were observed after the thermal shock test was completed. There was also no appearance of “blushing” in the scribe cuts, which is often caused by the layers absorbing moisture from the steam being blown into the cut.

### Example 11

Four test panels manufactured according to the procedure of Example 1 were tested for filiform corrosion resistance in the following manner. Each of the four test panels contained a specific metal layer in which the first, second, third and fourth test panels contained an aluminum, nickel, chromium and chromium-nickel alloy metal layer, respectively. The test panels were first scribed using the method described in Example 4. After being scribed, the test panels were placed in fog chamber of a CASS solution of Example 9 for a period of 6 hours. The test panels were placed at a 45° angle in the chamber to prevent puddles of the CASS solution in the scribe cut. After the test panels were removed from the chamber, they were thoroughly rinsed with deionized water to remove all CASS solution residues. The test panels then were directly placed in the humidity apparatus of Example 3. The test panels remained in the humidity apparatus for a period of 672 hours at the same conditions used in Example 3. After the test panels were removed from the humidity apparatus, the aluminum metal layer of the first test panel showed signs of creep and corrosion. It was observed that the other test panels displayed less than 4 mm of filiform corrosion from the scribe cut. Furthermore, it was observed that no filament corrosion growth occurred on the non-scribed areas of all of the test panels.

Although the above-described embodiments constitute the preferred embodiments, it will be understood that various changes or modifications can be made thereto without departing from the spirit and the scope of the present invention as set forth in the appended claims.

What is claimed is:

1. A layered structure comprising a substrate, a thermally-cured leveling layer overlying the substrate, at least one intermediate layer overlying the thermally-cured leveling layer, and a thermally-cured top coat layer overlying the at least one intermediate layer, said thermally-cured top coat layer having dispersed therein particles selected from the group consisting of (a) decorative particles and (b) texture particles.

2. The layered structure of claim 1, said thermally-cured top coat layer having decorative particles and texture particles dispersed therein.

3. The layered structure of claim 1, said thermally-cured top coat layer comprising a thermoset material that is clear and colorless, wherein said particles comprise 20 weight percent or less of the thermally-cured top coat layer.

4. The layered structure of claim 1, said at least one intermediate layer being selected from the group consisting of (a) a decorative metal layer, (b) a radiation-cured layer, (c) a paint layer and (d) a pretreatment layer.

5. The layered structure of claim 4, said radiation-cured layer being a cross-linked acrylated urethane polymer.

6. The layered structure of claim 1, said particles not being in direct contact with said at least one intermediate layer.

7. The layered structure of claim 1, a portion of said particles extending above the top surface of the thermally-cured top coat layer.

8. The layered structure of claim 1, said decorative particles being selected from the group consisting of: mirror particles, glass particles, beads, powder particles, colored glass particles, prisms, reflective material particles, metal flakes, mica particles, glitter particles and combinations thereof.

9. The layered structure of claim 1, said thermally-cured top coat and said thermally-cured leveling layer comprising substantially the same curable material.

10. The layered structure of claim 1, further comprising a clear coat layer overlying said top coat layer, said clear coat layer being comprised of a thermoset material that is clear and colorless.

11. The layered structure of claim 10, said top coat layer and said clear coat layer being comprised of substantially the same thermoset material.

12. The layered structure of claim 10, said particles being decorative particles, said top coat layer having a thickness of 5 to 50 microns and said clear coat layer portion having a thickness of 5 to 50 microns.

13. The layered structure of claim 10, said particles being texture particles, said top coat layer having a thickness of 20 to 750 microns and said clear coat layer portion having a thickness of 5 to 200 microns.

14. A method of applying a top coat layer over a substrate comprising the steps of:
a) providing a substrate having a substrate surface,
b) providing a thermally-cured leveling layer overlying said substrate surface,
c) providing at least one intermediate layer overlying said thermally-cured leveling layer,
d) providing a thermally-cured top coat layer overlying said at least one intermediate layer, said top coat layer having particles dispersed therein selected from the group consisting of (a) decorative particles and (b) texture particles.

15. The method of claim 14, wherein a portion of said particles extending above the top surface of the thermally-cured top coat layer.

16. The method of claim 14, said thermally-cured top coat layer being provided by
depositing a powder blend of a thermally-curable material and said particles onto said at least one intermediate layer to provide an uncured thermally-curable layer, and
curing said thermally-curable layer to provide said thermally-cured top coat layer.

17. The method of claim 16, comprising curing said thermally-curable layer by the following steps:
pre-flowing the thermally-curable layer by heating the uncured blend of thermally-curable material and said particles from the temperature at which it is deposited and maintaining said blend at about 200° F. for a period of 5 to 10 minutes, and subsequently
maintaining said thermally-curable layer at a curing temperature of approximately 260 to 375° F. from 10 to 45 minutes to provide said thermally-cured top coat layer.

18. The method of claim 14, further comprising:
depositing a blend of a first thermally-curable material and said particles onto the at least one intermediate layer to provide an uncured thermally-curable first layer portion,
pre-curing the thermally-curable first layer portion by heating the layer from the temperature at which it is deposited to a pre-cure temperature of approximately 250 to 290° F. for 1 to 12 minutes,
subsequently depositing a second thermally-curable material onto the surface of the pre-cured first layer portion to provide an uncured thermally-curable second layer portion, and
curing said pre-cured first layer portion and said uncured thermally-curable second layer portion by maintaining said first layer portion and said second layer portion at a curing temperature of approximately 260 to 375° F. from 10 to 45 minutes to provide said thermally-cured top coat layer and a thermally-cured clear coat layer respectively.

19. The method of claim 18, said blend of first thermally-curable material and said particles being deposited in a dry, powder form.

20. The method of claim 18, said second thermally-curable material being deposited onto the surface of the pre-cured top coat layer in a dry, powder form.

21. The method of claim 18, further comprising cooling the thermally-cured top coat layer from said curing temperature to a temperature of approximately 100 to 200° F.

22. The method of claim 18, said first thermally-curable material and said second thermally-curable material comprising substantially the same curable material.

23. The method of claim 18, said thermally-cured top coat layer having decorative particles and texture particles dispersed therein.

24. The method of claim 18, said at least one intermediate layer being selected from the group consisting of (a) a decorative metal layer, (b) a radiation-cured layer, (c) a paint layer and (d) a pretreatment layer.

25. The method of claim 18, said particles not being in direct contact with said intermediate layer.
